(19) United States
(12) Patent Application Publication
(10) Pub. No.: US 2026/0260184 A1
(43) Pub. Date: Sep. 3, 2026

(54) AGGREGATOR MODEL FOR CONTACT CENTER

(71) Applicant: JPMORGAN CHASE BANK, N.A., New York, NY (US)

(72) Inventors: Ali-Zahir AKHTAR, Bear, DE (US); Nitin DHIR, Hockessin, DE (US); Ameen IBOU, New York, NY (US); Ganesh VEERAMANI, New York, NY (US)

(21) Appl. No.: 19/066,462

(22) Filed: Feb. 28, 2025

(51) Int. Cl. G06Q 10/0631; G06N 20/20; G06Q 10/04; G06Q 10/105; H04M 3/51

(52) U.S. Cl. CPC G06Q 10/063112; G06N 20/20; G06Q 10/04; G06Q 10/105; H04M 3/5175; H04M 2203/402; H04M 2203/403; H04M 2203/558

(57) ABSTRACT

Methods and systems consistent with the disclosure include a method for scheduling and resource optimization including steps of receiving, by an interaction module of a scheduling and resource optimization system executed by one or more processors, a plurality of communications, wherein each communication comprises a record; storing, by the interaction module, the record in a database; determining, by the interaction module, a plurality of tasks based on the record by comparing the record with each of a plurality of model tasks, each task being associated with a duration; determining, by a machine learning model of an optimizer executed by the one or more processors, a real-time demand plan based on the one task and an availability and an employee of the plurality of employees for each task based on a semantic similarity of a worker profile and each task and an availability of the employee.

### BACKGROUND OF THE INVENTION

### 1. Field Of The Invention

Embodiments generally relate to systems and methods for contact centers relating to scheduling and resource optimization.

### 2. Description of the Related Art

Current contact centers have limitations in scheduling appropriate resources based on changes in demand. Current contact centers are reactionary instead of predictive. Contact centers today are operated in a silo mode where human services wait until a customer's needs are identified. This leads to a significant portion of contact centers being unused for large periods of time. This is inefficient and costly. There is a need for an improved contact center system that performs schedule optimization, uses a unified technology platform, generates demand forecast, automates detection of resource gaps and associated schedule changes, and resource optimization. Further, there is a need for prioritization of received messages and efficient management of institution resources in response to the received messages.

### SUMMARY

Methods and systems consistent with the disclosure include a method for scheduling and resource optimization including steps of receiving, by an interaction module of a scheduling and resource optimization system executed by one or more processors, a plurality of communications comprising a call, a text, an email, or a chat, wherein each communication comprises a record; storing, by the interaction module, the record in a database; determining, by the interaction module, a plurality of tasks based on the record by comparing the record with each of a plurality of model tasks, each task being associated with a duration; determining, by an administrative module executed by the one or more processors, an availability of a plurality of employees based on an event and a work schedule; determining, by a machine learning model of an optimizer executed by the one or more processors, a real-time demand plan based on the one task and the availability; determining, by the machine learning model, an employee of the plurality of employees for each task based on a semantic similarity of a worker profile and each task and an availability of the employee; and scheduling, by the administrative module upon receiving the employee determination from the optimizer, the employee for each task.

In some embodiments, each task may be further associated with a training requirement. In some embodiments, each task may be further associated with a service level agreement (“SLA”) requirement. In some embodiments, each task may be further associated with a type. In some embodiments, one task of the plurality of tasks and a different task of the plurality of tasks are associated, by the interaction module, with the same type and both the task and the different task are assigned, by the optimizer, to one employee of the plurality of employees. In some embodiments, the method may further comprise determining, by the machine learning model, the employee of the plurality of employees for each task is further based on a decision tree wherein each branch is assigned a weight. In some embodiments, the decision tree may include one or more binary branches. In some embodiments, the employee may be assigned an aggregate of weights of each decision tree branch if each binary branch does not exclude the employee.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for resource optimization according to an embodiment.

FIG. 2 illustrates a method for resource and schedule optimization according to an embodiment.

FIG. 3 illustrates a method for scheduling specialists according to an embodiment. As discussed during the review, this should be removed.

FIG. 4 illustrates an exemplary computing system for implementing aspects of the present disclosure.

### DETAILED DESCRIPTION OF PREFERRED EMBODIMENTS

Embodiments are directed to systems and methods for contact centers relating to scheduling and resource optimization.

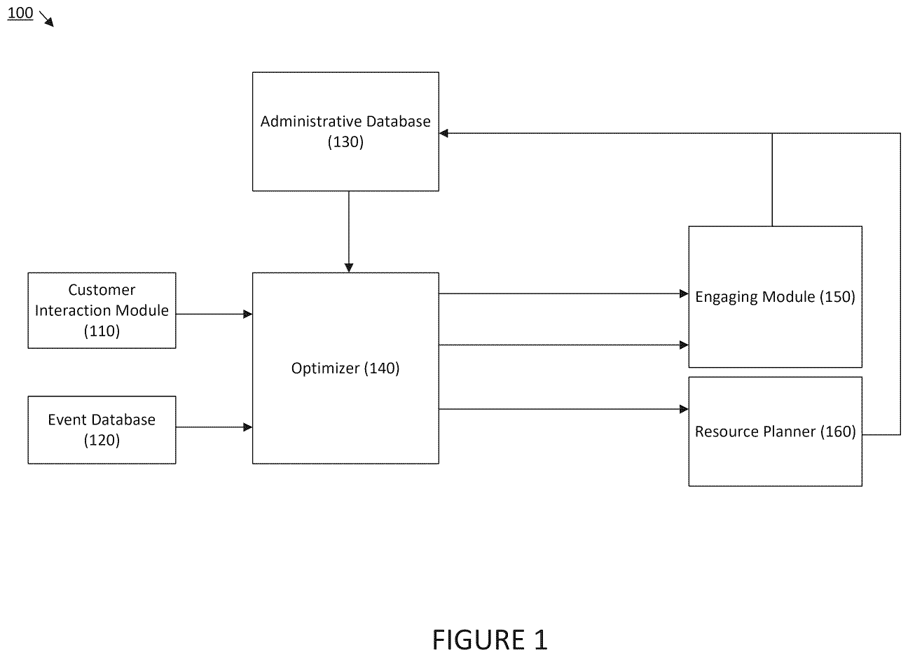

Referring to FIG. 1, a contact center system 100 for scheduling and resource optimization is illustrated according to some embodiments.

System 100 may include a customer interaction module 110. Customer interaction module 110 may be configured to receive calls, make outbound calls, receive emails, receive a chat, and/or receive a list of currently utilized resources. Calls received or made may be made over a phone resource through a phone network connected to an internet connection or over an internet connection, and thus can be received and tracked by the customer interaction module 110. The customer interaction module 110 may retain a record of each call (e.g., save in a database), the record including one or more of a date, time, associated account or individual, and/or a speech-to-text translation of the call performed by an associated speech-to-text application. Emails and chat may be received through an email program and/or chat application connected to the customer interaction module 110. The real-time data is collected by a computer on the network interacting through real-time feeds and a historical feed with regards to messaging or chatting.

In some embodiments, a demand or a utilization of a resource may be provided by customer interaction module 110 to optimizer 140. The demand may include, for example, a customer's need for a task such as a request for services (e.g., new account, check status of transfer, initiate transfer, product inquiry, technical issue) and associated callback. The utilization of a resource may include, for example, a current use of a chat. Demand information may be based on one or more customers accessing a company's services through physical or online services, based on scheduled or unscheduled interactions. The scheduled interactions may be calendared. The unscheduled interactions may be detected by use of online applications (e.g., phone, messaging, websites). Customer interaction module 110 may collect the demand, the availability, or the utilization of a resource by a communication with a client over email, phone call, chat, or input by a human administrator such as in back office. Customer interaction module 110 may search for a service level agreement (“SLA”) associated with the communication based on gathered information such as a client identifier and supply the SLA to optimizer 140.

Event database 120 may include a number of set or developing events. Event database 120 may pull from the number of set or developing events from an institution intranet or an internet source (e.g., a weather service, a news organization). Further, manual entry of events into event database 120 may occur. The number of set events may be calendar holidays, elections, company events (e.g., retreats, scheduled all-hands meetings, etc.) or weekends or hours of a day. Developing events may include weather events, site-specific events (e.g., planned maintenance, local all-hands meetings, maintenance, property or asset disturbances, etc.), global corporate events, and/or geo-political events. An event may be provided to optimizer 140 by event database 120. In some embodiments, event database 120 may determine whether an event is likely to affect a contact center based on a match of a call center geography and a geography of the event.

Administrative database 130 may include a list of employees and an availability and/or schedule of each employee. Administrative database 130 may be automatically generated based on a distribution of employees, for example with more employees available for peak times and less for off-peak times. Modifications for different employees may be entered into an administrative database 130 including details such as a scheduled portion of a day, a break, a holiday, an emergency, a work-from-home day, etc. The availability and/or schedule may show the scheduled portion of a day including being scheduled as busy, available, on break, off-work, in a meeting, training, coaching, or over-time. Administrative database 130 may include an agent profile including a type of work of each employee. The employee's calendar may show a scheduled portion of a day including being scheduled as busy, available, on break, off-work, in a meeting, etc. An availability and/or schedule of each employee may be provided to optimizer 140 by administrative database 130.

Optimizer 140 may perform real-time demand planning based on each employee availability and/or schedule from administrative database 130, resource demand and utilization from customer interaction module 110, and events from event database 120. Optimizer 140 may perform real time demand planning based on a desired time period such as during a current workday, between 0 and 30 days (training, location), between 30 and 90 days (training), and greater than 90 days (onboarding, training). Optimizer 140 may use inputs of demand and supply, where demand includes service requests and/or other information from customer interaction module 110, and supply includes a number of employees, an availability of each employee, a capability of each employee, and/or other information from administrative database 130. Optimizer 140 may split the availability into one or more time periods such as thirty minute increments. Optimizer 140 may organize each employee by training in one or more particular areas (e.g., sales, technical, customer service, language, or similar) and access to one or more tools (e.g., software programs, hardware, managerial capability).

In some embodiments, optimizer 140 may match a transcript to a queue based on a profile associated with the queue. For example, a machine learning model of optimizer 140 may use a semantic similarity between the queue and the profile. For example, the profile may be assigned one or more keywords associated with specialties handled by operators associated with work items.

Optimizer 140 may organize each demand by one or more of historically peak or non-peak timeframes, a time horizon for each demand. In some embodiments, optimizer 140 may link one or more demands if they involve similar subject matter. Linked demands may be assigned to one employee to maintain efficiency and/or workflow for similar tasks. Optimizer 140 may organize each demand by SLA requirement. Optimizer 140 may organize each demand by one or more of historically peak or non-peak timeframes, a time horizon for each demand. Optimizer 140 may include a machine learning model that uses one or more decision trees to determine whether to assign the demand to one employee among a plurality of employees. For example, the decision tree may include branches for the demand may be associated with one or more of a SLA requirement, a duration, a time horizon for completion, a type, and a training requirement, and/or for each perspective employee may include one or more of a level of training, a tool availability, a resource availability, a position, and an availability (e.g., intraday, over a time period, within the time horizon for completion). The machine learning model may apply the decision tree to determine which perspective employee to match with each demand. In some embodiments, each branch of the decision tree may be weighted for binary considerations (e.g., intraday availability, level of training, type) or scaled considerations (e.g., duration, position, availability over a time period, availability within the time horizon for completion, availability of support staff/resources) according to whether a consideration is involuntary (e.g., binary) or voluntary (e.g., may be scaled). Thus, optimizer 140 may determine one or more employees for each task.

In some embodiments, the machine learning model may determine a semantic similarity between a task and a worker profile. In some embodiments, the semantic similarity may be a branch of the decision tree and be assigned a weight according to the semantic similarity. In some embodiments, a threshold may be used to determine if the employee should be assigned based on a minimum semantic similarity. Optimizer 140 may predict a work type, a shift, and/or a type of support available/necessary based on the demand including how long the work requirement should take. Optimizer 140 may employ a sentiment analysis by determining an emotionality factor associated with each work requirement and determining when an employee has exceeded an emotionality threshold within a time period. Optimizer 140 may assign a lower emotionality threshold work requirement to the employee, a break, or a training in response to an emotionality threshold being exceeded. In some embodiments, the machine learning model may use the emotionality factor as a binary or scaled consideration in a decision tree.

In some embodiments, the machine learning model may match supply side and demand side. For example, the machine learning model may determine demand size based on historical data, a location, a time, an event, a time of day, a time of week, a holiday and/or types of products. The machine learning model may determine a number of workers required for a number of tasks, wherein the machine learning model may determine if a duration for the number of tasks exceeds an availability of the number of workers required for the number of tasks. If the duration exceeds the availability, optimizer 140 may be configured to communicate with administrative database 130 to change a schedule for one or more employees including assigning training for one or more required tasks during available time for example, for a new product, assigning work time outside of a standard or existing schedule, and/or assigning a new location for a time period associated with a task duration.

In some embodiments, optimizer 140 may provide real time demand planning based on a current workday and between 0 and 30 days to engaging module 150. Optimizer 140 may provide real time demand planning based on between 30 and 90 days and greater than 90 days to resource planner 160. It is understood that the timeframes disclosed herein are exemplary and different periods of time may be used.

In some embodiments, optimizer 140 may generate a schedule modification bid(s) based on a desired time period. The schedule modification bid may include a work assignment. Optimizer 140 may identify the schedule modification bid based on a gap between an employee availability and/or schedule and a demand, utilization, or an event. The schedule modification bids may be provided to engaging module 150.

Engaging module 150 may receive schedule modification bids and may package them in one or more communications to identified employees. The identified employees may be identified based on a first matching criteria including being available, a geographic area, in an assigned company organizational unit, or knowledgeable about a type of work (trained on a certain project, call types they took recently) associated with the schedule modification bid. Engaging module 150 may be configured to send an email, chat, text, or phone call to the identified employee. In some embodiments, engaging module 150 may be configured to receive approval or rejection of the schedule modification bid through a communication from a trusted device or in a same medium that the schedule modification bid was provided through. Engaging module 150 may try multiple times in order for a schedule modification bid to be accepted.

Engaging module 150 may provide an accepted or rejected status of a schedule modification bid to administrative database 130. For example, a required time of an employee may be estimated and scheduled according to the schedule modification bid. For rejected bids, other potential employees may be matched based on a second matching criteria, different from the first matching criteria, including being available, a geographic area, in an assigned company organizational unit, or knowledgeable about a type of work associated with the schedule modification bid.

Resource planner 160 may prepare a remediation based on the real time demand planning from optimizer 140. The remediation may be short term or long term. Short term remediation may include providing training, changing work focus, or scheduling of employees (e.g., over time, more employees). Long term remediation may include a hiring plan or a capacity plan. The remediation may be provided to administrative database 130. Employees may be scheduled based on the remediation for training, re-skilling, scheduling, and new hires.

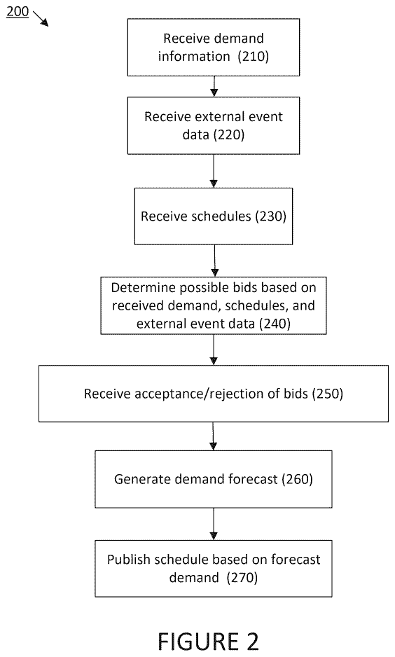

Referring to FIG. 2, a method 200 for generating and publishing a demand forecast is disclosed according to an embodiment.

Method 200 may include one or more steps including step 210. In step 210, a platform may receive demand information based on one or more customers accessing a company's services through physical or online services, based on scheduled or unscheduled interactions. The scheduled interactions may be calendared. The unscheduled interactions may be detected by use of online applications (e.g., phone, messaging, websites). The platform may be an application accessible through a user's electronic communication device and connected to a backend hosted by a server or computer. The application may be a set of instructions executed by a processor of the user's electronic communication device. The backend may be a set of instructions executed by a processor of a server or computer.

In step 220, the platform may receive external event data. The external event data may be input. The external event data may be determined based on online databases, an internet search, alerts from news sources (e.g., weather, disruption events such as fires, terrorist attacks, protests, or similar, energy events such as a black out or brown out), or manually input. In some embodiments, a machine learning model of the platform may determine, based on a predefined search within a time period, one or more events based on the external event data. The machine learning model may determine a connection between a geographic location and the one or more events by determining a likelihood (e.g., by likely size of event by actual reported or guessed effect, likely timeline of event by actual reported or guessed effect, movement of location of event by actual reported or guessed effect, actual reported or guessed beginning or end of event) of affecting the geographic location. The geographic location include one or more of a building or group of buildings, a portion of a city containing the building or group of buildings, and a region or country containing the building or group of buildings. The geographic location may be considered at multiple levels to account for differences of news sources.

In step 230, the platform may receive schedules of employees and/or sites. The platform may store schedules in a schedule database. In some embodiments, the schedules may be automatically generated based on one or more work profile templates with a number of work hours, possible overtime hours, weekend hours, blocked off time, or similar. The schedules may include availability, potential or verified meetings or office time, work hours, or any other calendar status discussed herein. In some embodiments, schedules may be manually input or edited.

In step 240, the platform may determine possible bids based on received demand, an affinity of the received demand, external event data, and the received schedules. For example, a work assignment may be a client meeting, a client portfolio review, a technical issue, an employee-manager meeting, or similar. The platform may, through an application programming interface (“API”), execute a call with a possible bid as a parameter of the call to an API gateway of the schedule database. The platform may direct the call to one or more connected computerized schedules executed by one or more computers through the API gateway to gather information regarding the computerized schedules to update the schedule database, wherein an availability or similar of the computerized schedule may be a response to the call. In some embodiments, the API gateway may direct the call based on an affinity in the parameter and an affinity of one or more potential workers. In some embodiments, the API may be stateless. In some embodiments, the API may be pending until it is responded to or until expiration.

In step 250, the platform may receive offers based on the bids. The offer may be a response to the API call indicating availability or partial availability. For example, the offer(s) might be an acceptance, rejection, or modification of the bid. In some embodiments, the offers may be automatically generated based on one or more computerized schedules. In some embodiments, the offers may be manually responded through a user interface accessible by the one or more computers or through other communication (e.g., text, email). In some embodiments, the offers may be ranked based on one or more profile matches such as geographic location, affinity, cost requirement (e.g., considering a level of worker, overtime of the worker), time between other work assignments or other unavailability, or actual or likelihood of external event. In some embodiments, the modification of the bid may be accepted to change a time of the work assignment, shorten the work assignment time, or modify the work assignment to be split into different times.

In step 260, the platform may generate a demand forecast based on received demand, offers, external event data, received schedules, and/or the acceptance, modification, and/or rejection of the bids. In some embodiments, the demand forecast may be used by the platform to generate new bids for the one or more computerized schedules. In some embodiments, the demand forecast may be used by the platform to respond to demand or lack of demand by scheduling training or as otherwise discussed herein.

In step 270, the platform may publish a schedule based on the demand forecast. The schedule may be displayed by a computer in operative connection with the platform.

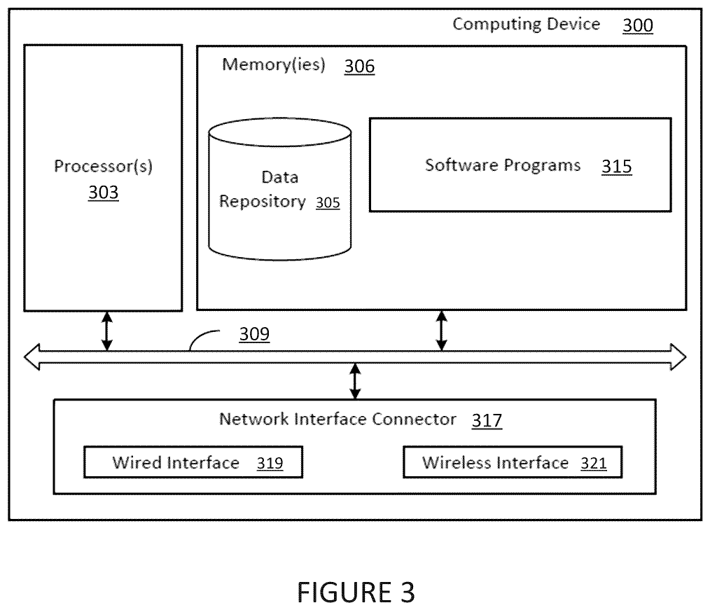

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general embodiments of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for scheduling and resource optimization comprising steps of:
receiving, by an interaction module of a scheduling and resource optimization system executed by one or more processors, a plurality of communications comprising a call, a text, an email, or a chat, wherein each communication comprises a record;
storing, by the interaction module, the record in a database;
determining, by the interaction module, a plurality of tasks based on the record by comparing the record with each of a plurality of model tasks, each task being associated with a duration;
determining, by an administrative module executed by the one or more processors, an availability of a plurality of employees based on an event and a work schedule;
determining, by a machine learning model of an optimizer executed by the one or more processors, a real-time demand plan based on the one task and the availability;
determining, by the machine learning model, an employee of the plurality of employees for each task based on a semantic similarity of a worker profile and each task and an availability of the employee; and
scheduling, by the administrative module upon receiving the employee determination from the optimizer, the employee for each task.

2. The method of claim 1, wherein each task is further associated with a training requirement.

3. The method of claim 1, wherein each task is further associated with a service level agreement (“SLA”) requirement.

4. The method of claim 1, wherein each task is further associated with a type.

5. The method of claim 4, wherein one task of the plurality of tasks and a different task of the plurality of tasks are associated, by the interaction module, with the same type and both the task and the different task are assigned, by the optimizer, to one employee of the plurality of employees.

6. The method of claim 1, wherein determining, by the machine learning model, the employee of the plurality of employees for each task is further based on a decision tree wherein each branch is assigned a weight.

7. The method of claim 6, wherein the decision tree includes one or more binary branches.

8. The method of claim 7, wherein the employee is assigned an aggregate of weights of each decision tree branch if each binary branch does not exclude the employee.

9. A system for scheduling and resource optimization comprising:
receiving, by an interaction module of a scheduling and resource optimization system executed by one or more processors, a plurality of communications comprising a call, a text, an email, or a chat, wherein each communication comprises a record;
storing, by the interaction module, the record in a database;
determining, by the interaction module, a plurality of tasks based on the record by comparing the record with each of a plurality of model tasks, each task being associated with a duration;
determining, by an administrative module executed by the one or more processors, an availability of a plurality of employees based on an event and a work schedule;
determining, by a machine learning model of an optimizer executed by the one or more processors, a real-time demand plan based on the one task and the availability;
determining, by the machine learning model, an employee of the plurality of employees for each task based on a semantic similarity of a worker profile and each task and an availability of the employee; and
scheduling, by the administrative module upon receiving the employee determination from the optimizer, the employee for each task.

10. The system of claim 9, wherein each task is further associated with a training requirement.

11. The system of claim 9, wherein each task is further associated with a service level agreement (“SLA”) requirement.

12. The system of claim 9, wherein each task is further associated with a type.

13. The system of claim 12, wherein one task of the plurality of tasks and a different task of the plurality of tasks are associated, by the interaction module, with the same type and both the task and the different task are assigned, by the optimizer, to one employee of the plurality of employees.

14. The system of claim 13, wherein determining, by the machine learning model, the employee of the plurality of employees for each task is further based on a decision tree wherein each branch is assigned a weight.

15. The system of claim 14, wherein the decision tree includes one or more binary branches.

16. The system of claim 15, wherein the employee is assigned an aggregate of weights of each decision tree branch if each binary branch does not exclude the employee.

17. A non-transitory computer readable storage medium, including instructions stored thereon, which when read and executed by one or more computer processors, cause the one or more computer processors to perform steps comprising:
receiving, by an interaction module of a scheduling and resource optimization system executed by one or more processors, a plurality of communications comprising a call, a text, an email, or a chat, wherein each communication comprises a record;
storing, by the interaction module, the record in a database;
determining, by the interaction module, a plurality of tasks based on the record by comparing the record with each of a plurality of model tasks, each task being associated with a duration;
determining, by an administrative module executed by the one or more processors, an availability of a plurality of employees based on an event and a work schedule;
determining, by a machine learning model of an optimizer executed by the one or more processors, a real-time demand plan based on the one task and the availability;
determining, by the machine learning model, an employee of the plurality of employees for each task based on a semantic similarity of a worker profile and each task and an availability of the employee; and
scheduling, by the administrative module upon receiving the employee determination from the optimizer, the employee for each task.

18. The non-transitory computer readable storage medium of claim 17, wherein determining, by the machine learning model, the employee of the plurality of employees for each task is further based on a decision tree wherein each branch is assigned a weight.

19. The non-transitory computer readable storage medium of claim 18, wherein the decision tree includes one or more binary branches.

20. The non-transitory computer readable storage medium of claim 19, wherein the employee is assigned an aggregate of weights of each decision tree branch if each binary branch does not exclude the employee.
